(19) United States
(12) Patent Application Publication
(10) Pub. No.: US 2010/0180273 A1
(43) Pub. Date: Jul. 15, 2010

(54) Virtualized operating system

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/352,446

(22) Filed: Jan. 12, 2009

(51) Int. Cl. G06F 9/455

(52) U.S. Cl. 718/1

(57) ABSTRACT

Multiple operating systems that run at the same time. A virtualization layer can run on a multiple core operating system to run the different operating systems. The cores can be powered down, for example, when one of the operating systems is not running.

### BACKGROUND

Virtualization has been used as a way to allow interfaces between different hardware elements. For example, FIG. 1 illustrates how a processor 100 accepts information such as instructions and data only in its native language, here the instructions that are executable by the processor 102. A virtualization layer 110 can run on the processor. The virtualization layer communicates directly with hardware and software in the way it is intended and also communicates with the processor or with a low level software layer, such as the BIOS, or a low level language, that is running on the processor.

For example, the processor 100 or the low level software layer, may prefer to communicate directly with memories of a type such as 120. This may be a preference in a way that the processor communicates or a speed of communication. The virtualization layer 100 allows using a different form of memory 120 to be any of different kinds of memory including 120 as shown, or may be a hard drive 121 or any kind of data storage. That same hard drive 121 can also be communicated by the virtualization layer as other kind of memory, e.g. as a standard hard drive.

The virtualization layer can communicate with user interface 122 and any kind of software 123.

### SUMMARY

The present disclosure recognizes that virtualization is a very powerful tool and can be used for many features not previously possible in the prior art. Embodiments describe virtualization layers that are optimized for multiple core processors. According to an embodiment, one of the cores may act as an arbiter for the other cores.

Another embodiment describes different functions being carried out by different cores of the processor.

Another embodiment describes rearranging a function to core table to be equalize the core load. This rearrangement can be based on number of instructions or heat, or can be based for example on response time of the cores.

Another embodiment describes how different cores in a multiple core processor can run different operating systems simultaneously.

Another embodiment describes a desktop formed of different operating systems running simultaneously.

Another embodiment describes a configurable part that can be used with the cores.

### BRIEF DESCRIPTION OF THE DRAWINGS

These and other aspects will now be described in detail with reference to the accompanying drawings, wherein:

FIG. 1 shows a prior art view of virtualization;

FIG. 2 illustrates an embodiment where there are multiple cores including an arbiter, and each of the multiple cores is running a virtual operating system;

FIG. 3 shows operating systems and layers in multiple processors; and

FIG. 4 shows an embodiment where certain cores can be powered down when not in use.

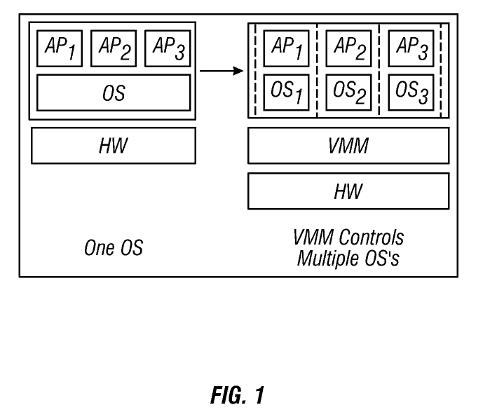

### DETAILED DESCRIPTION

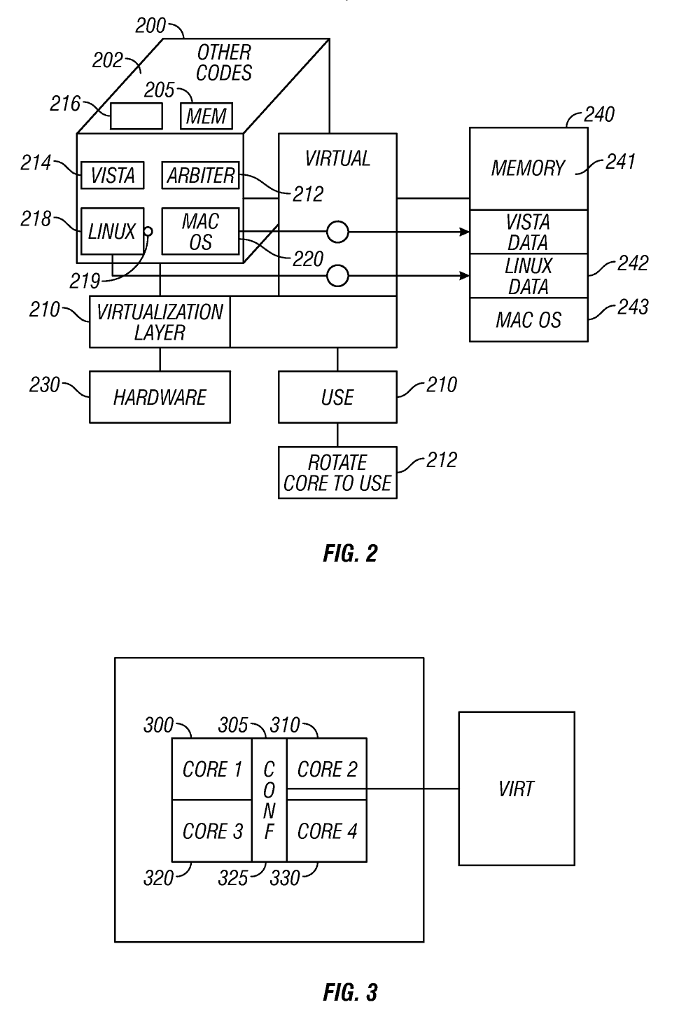

A first embodiment is described with reference to FIG. 2. The processor 200 in FIG. 2 is a multiple core processor. While four cores are shown, other cores 202 are contemplated, for an n core processor, where n is 4, 8, 16, 32, 64 or any number of processors.

The virtualization layer 210 and runs directly on top of the processor 200. The processor, for example, may first load the bios, and on top of the bios runs directly the virtualization layer.

The virtualization layer communicates directly in machine language with the processor and its cores. In an embodiment, the processor may also include on-chip chip memory 205. The on-chip memory 205 may be a single very fast memory associated with multiple cores, or may be multiple different memories each associated with one core.

According to an embodiment, the virtualization layer 210 first assigns one of the cores as an arbiter core. This core runs an arbiter routine. The arbiter makes decisions of what processes are run and how they are assigned.

Throughout this embodiment, the techniques describe different actions being assigned individually to different cores. However, it should be understood that these same concepts may be applied to a system in which the actions are carried out using different threads that are randomly assigned between the cores.

Here, the arbiter core is shown as 220. The arbiter core runs a routine to decide which cores execute which programs.

Different operating systems may be better at carrying out different operations. For example, some people prefer the Mac operating system for image and photographic processing. The Microsoft Windows operating systems such as Vista, however, have more wide acceptance, and there may be more programs available for Vista. Some programs, and especially small developer programs, are only available for the Windows OS. According to an embodiment, each of a plurality of cores is configured by the arbiter and virtualization layer to run a different operating system. In the embodiment, cores 214 and 216 are configured to be Vista/Microsoft cores. Core 218 is configured to be a Linux core. Core 220 is configured to be a Mac OS core. Each of these cores are then configured by the arbiter in a way that allows the cores to run multiple operating systems simultaneously or substantially simultaneously, as though there were native operating systems.

Different hardware is also driven by the virtualization layer. The hardware is generically shown is 230, and may include input/output devices and other hardware. Core 214 is wholly configured as a processor that runs a Microsoft operating system, and can run a virtual operating system. The virtualization layer 210 also connects to a memory bank shown as 240. The memory bank may be separated to stores Microsoft data 241, Linux data 242 as well as Mac OS data 243. It should be understood that while this embodiment shows only three operating systems, that any number of operating systems can be similarly Rod. Each processor is configured by the virtualization layer to run a different operating system in this way. The virtualization layer also monitors use, in a use table 210.

When operating systems are not being used, the cores associated with those operating systems can be powered down, as described herein.

At 212, the virtualization layer may rotate cores for use based on one of different criteria. According to one criterion, the core table may be rearranged during times of processor non-use, to attempt to equalize the load among the processors in at least one embodiment. For example, this may use a temperature sensor such as 219 on each core, and rearrange the core-to-function table so that the temperatures equalize among the cores over time. The relocation may be at random, e.g., by randomly reassigning different operating systems to the different cores at different times.

This may also rotate the cores that are inactivated or powered down, e.g., randomly, or in some sequence.

According to another embodiment, each core may be formed with associated hardware that can be turned on or turned off. For example, FIG. 3 illustrates how core 1 300 and core 2 310 may share a hardware portion 305. The hardware portion 305 can be a digital signal processor, or an FPGA, or in general any configurable hardware part. The configurable part can be used by either of the core 1 or core 2 under control of the virtualization layer. Similarly, core three 320 may share a configurable part 325 with core four. The mapping between the configurable parts and the cores themselves can be changed, for example, there could be one configurable part for all for cores, or one configurable part for each core. These configurable parts may facilitate use of the processor with certain languages. For example, if a language requires an entire set of machine level instructions that are not supported by the core 300, the configurable portion 305 can be configured by the virtualization layer 332 carry-on this function.

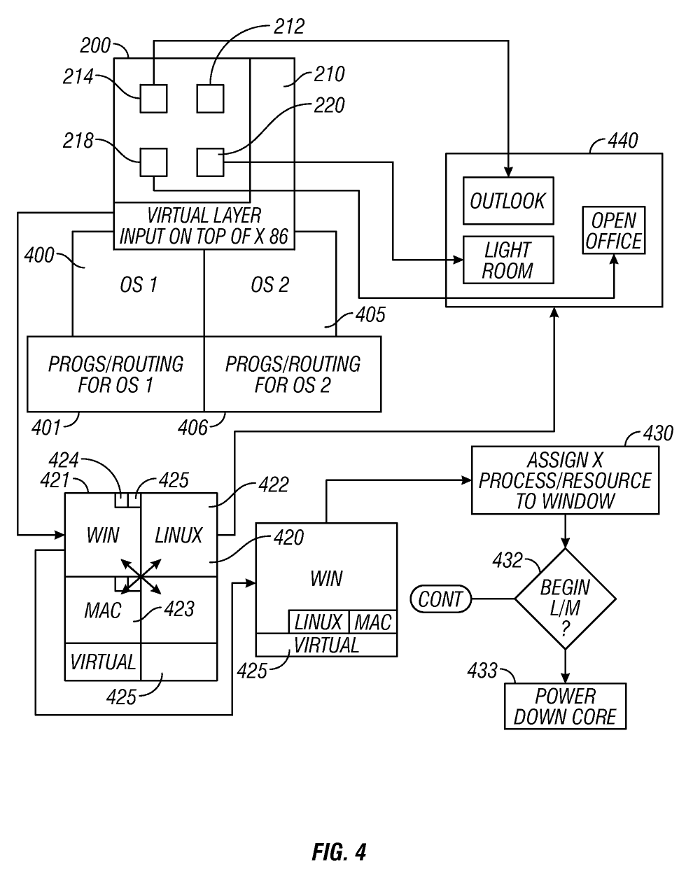

FIG. 4 represents the way in which the virtualization layer interfaces between the programs. The processor 200 is shown with its multiple cores 214, 212. Virtualization layer 210 runs on the processor, for example an x86 processor. Operating system one 400 runs through the virtualization layer and communicates to one of the cores 218. Operating system two 405 runs through the virtualization layer and communicates to a different core 220. The programs and routines for operating system one are shown generically as 401, communicating with the operating system one. The programs and routines for operating system to are shown as 406, communicating with the operating system two. The system can run multiple operating systems in this way at the same time, and multiple programs for the operating system. The term “same time” as used herein, means as close to the same time as they can run. Two instructions that are executed one right after the other are considered to run at the same time.

According to another embodiment, the virtualization layer itself runs an operating system shown as 420 which provides different configurable Windows for the different operating systems. For example, FIG. 4 shows how the screen can include a section 421 for the Windows program, 422 for the Linux programs and 423 for the Mac programs. Any of these window portions include a minimize button 424 and a maximize button 425. Maximizing the windows causes Windows programs to take up most of the screen, with the Linux and Mac programs or desktop being relegated to minimized windows.

The virtualization layer always runs as 425 at the bottom of the screen, allowing functions that are specific to the virtualization layer.

Another embodiment of the virtualization layer 210 uses the other processor cores and also may use spare capability on the running processor core such as 212 as virtual processors for the operating system. When, for example, the Windows operating system is maximized, the virtualization system may do two different things. First of all, it may assign an extra processor to Windows, or more generally to the now-active operating system. For example, processor 216 may be assigned to Windows, or may be a spare processor core that is used for overflow programs. This can assign extra processor resources to the operating system that is in focus.

432 determines whether any of the minimized programs are running in the background. If not, the core that is associated with those programs is powered down at 433. In this way, some of the cores can be powered down when not in use.

The core may be powered down by completely turning off power consumption of the core, or by allowing that core only to consume only some minimal amount of power, e.g., to execute watchdog timers, etc. The powering down of the core preferably reduces the power consumption of the powered-down core by at least 80% or 90% as compared with a fully functioning core.

However, one advantage of this system is that for example in the split screen shown as 420, the user can select and view windows from different operating systems all at the same time. For example, the user can have open a Linux word processor, a Mac photo program, and a Windows communication program such as Outlook. Each of these windows can be simultaneously displayed on the screen. For example, screenshot 440 shows Outlook running under Windows, controlled by core 214. It shows open office under Linux controlled by core 218 through the virtualization layer. It shows light room under Mac controlled by the core 220 through the virtualization layer.

Although only a few embodiments have been disclosed in detail above, other embodiments are possible and the inventors intend these to be encompassed within this specification. The specification describes specific examples to accomplish˜more general goal that may be accomplished in another way. This disclosure is intended to be exemplary, and the claims are intended to cover any modification or alternative which might be predictable to a person having ordinary skill in the art.

For example, other OSes can be used in this way.

Moreover, while the above describes segregating tasks by cores, another embodiment may segregate tasks by threads, so that the threads can dynamically be assigned to whatever processor resources exist.

The spare cores or processor capability can be powered down even when the tasks are in threads, by determining that a whole one or more cores need not be used, and powering down that core.

The powered down core may be moved around on the chip to allocate heating effects.

Also, the inventors intend that only those claims which use the-words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A system, comprising:
A computer running a first program under a first operating system, and the same computer running a second program under a second operating system at the same time as said first program, and said computer producing outputs indicating both said first program and said second program at the same time.

2. A system as in claim 1, wherein said wherein said computer has first and second processing cores, and said first operating system runs on said first processing core, and said second operating system runs on said second core.

3. A system as in claim 1, wherein said computer runs a virtualization routine that communicates with said computer and which runs both said first operating system and said second operating system.

4. A system as in claim 1, wherein said first operating system is a windows operating system, and said second operating system is one of Linux or Mac operating system.

5. A system as in claim 3, wherein said computer has first and second processing cores, and said virtualization routine runs said first operating system on said first processing core, and runs said second operating system on said second core.

6. A system as in claim 5, wherein said computer has additional processing cores, one of said additional processing core running a third operating system.

7. A system as in claim 2, wherein said computer reduces a power consumption when one of said operating systems is idle by powering down a core which is running said one of said operating systems that is idle.

8. A system as in claim 7, wherein said computer periodically changes which of said processing cores is powered down.

9. A computing device comprising:
a plurality of processing cores; and
a power down device that detects when at least one of said processing cores is not executing instructions, and powers down said at least one of said processing cores when said at least one of said processing cores is not executing said instructions, and allows at least one other of said processing cores to continue executing instructions while said one of said processing cores is powered down.

10. A device as in claim 9, wherein said power down device, changes which of a plurality of cores is powered down, such that a first processing core is powered down at a first time and a second processing core is powered down at a second time different than the first time.

11. A device as in claim 9, wherein said plurality of processing cores run a first program under a first operating system, and also run a second program under a second operating system at the same time as said first program.

12. A device as in claim 11, wherein said plurality of processing cores produce outputs are outputs on a display that shows results from both said first program under said first operating system, and said second program under said second operating system.

13. A system as in claim 11, wherein said processing cores are in a computer running a virtualization routine that communicates with said computer and wherein said virtualization routine controls said processing cores to run both said first operating system and said second operating system.

14. A system as in claim 13, wherein said first operating system is a windows operating system, and said second operating system is one of Linux or Mac operating system.

15. A system as in claim 13, wherein said processing cores include first and second processing cores, and said virtualization routine runs said first operating system on said first processing core, and runs said second operating system on said second core.

16. A system as in claim 15, wherein said power consumption is reduced when one of said operating systems is idle by powering down a core which is running said one of said operating systems that is idle. (f)

17. A method comprising:
Running a virtualization layer on a multiple core computer that operates multiple operating systems simultaneously, with a first operating system operating on a first core via said virtualization layer, and a second operating system operating on a second core of said multiple core computer via said virtualization layer.

18. A method as in claim 17, further comprising detecting a task load, and powering down a specified core to a power level that is at least 80% less than a full power of said core, when said task load is less than a specified level.

19. A method as in claim 18, further comprising rotating which core is powered down.

20. A system, comprising:
A computer, running a virtualization routine, and running a first program under a first operating system running on said virtualization routine, and the same computer running a second program under a second operating system on said virtualization routine at the same time as said first program, and said computer producing outputs indicating both said first program and said second program at the same time, said outputs produced as outputs to be displayed at the same time, said outputs representing current values from both said first program and said second program at the same time.

21. A system as in claim 20, wherein said computer has multiple processing cores, said first operating system running on said first processing core, and said second operating system running on said second processing core.
